(19) United States
(12) Patent Application Publication
(10) Pub. No.: US 2011/0047028 A1
(43) Pub. Date: Feb. 24, 2011

(54) TARGET ADVERTISEMENT SYSTEM AND METHOD IN MOBILE COMMUNICATION TERMINAL

(75) Inventors: Jin Cheon KIM, Yongin-si (KR); Won Joong Kim, Seongnam-si (KR)

Correspondence Address: Jae Y. Park, Kile Park Goekjian Reed & McManus PLLC, 1200 New Hampshire Ave. NW, Suite 570, Washington, DC, 20036, US

(73) Assignee: Company 100, Inc., Seongnam-si (KR)

(21) Appl. No.: 12/550,386

(22) Filed: Aug. 30, 2009

(30) Foreign Application Priority Data
Aug. 19, 2009 (KR) 10-2009-0076810

(51) Int. Cl. G06Q 30/00

(52) U.S. Cl. 705/14.52; 705/14.54

(57) ABSTRACT

A target advertisement method in a mobile communication terminal includes a first step of, in a web browser, transmitting keywords having high probability indexes among previously stored keywords, to an advertisement server via the Internet in an initially driven state; a second step of, in the advertisement server, selecting advertisements appropriate for the keywords transmitted from the web browser and transmitting the selected advertisements to the web browser via the Internet; a third step of, in the web browser, displaying the advertisements transmitted from the advertisement server on a first screen of the web browser; and a fourth step of implementing an information searching function or a web surfing function in conformity with a user's desire.

### BACKGROUND OF THE INVENTION

1. Field of the Invention

The present invention relates to technology that realizes target advertisement in a web browser installed in a mobile communication terminal, and more particularly, to a target advertisement system and method in a mobile communication terminal, which analyzes user preference information from search keywords of a user and site visit information, expects keywords having high probability for the user to input based on the preference information, and realizes a target advertisement on a first page of a web browser.

2. Description of the Related Art

These days, a web browser, which is installed and operated in a mobile communication terminal such as a mobile phone, is considered as an essential tool for accessing the Internet, and the importance of the web browser is further increased due to activation of the wireless Internet.

A recently developed smartphone has increased window size, calculation ability and memory capacity, and is equipped with an operation system (OS) which can operate a camera, a GPS and a complicated program. Therefore, by using the smartphone, it is possible to drive a browser capable of accessing not only the WAP (wireless application protocol) but also the same web environment as a PC (personal computer).

Due to development of the smartphone as a mobile communication terminal, activation of the Internet is accelerated in the field of a mobile communication terminal.

In conformity with this, the Internet advertisement market is growing fast in the field of a mobile communication terminal.

In this regard, differently from a desktop computer, it is rare for a mobile communication terminal to be shared by several or various users, and therefore, personal Internet using pattern information is preserved well. Also, personal information and position information stored in the mobile communication terminal can be utilized.

Meanwhile, as an exemplary advertisement method according to the conventional art which can be applied to a web page, AdSense of Google, Inc. residing at U.S.A. can be mentioned. In the AdSense advertisement method, an advertiser registers an advertisement along with keywords and a web page owner registers on AdSense. After that, when a user visits a web page, contents on the web page requested by the user are analyzed, and an advertisement link having keywords associated with the contents is inserted into the web page and is then transmitted. In this way, the user is incited to click the advertisement, whereby target advertisement can be realized.

However, in the AdSense advertisement method, the target advertisement is realized only based on temporary analysis of contents when the user visits the web page, and information associated with the user's preference is not collected and utilized for determination of a target advertisement. Also, in the AdSense advertisement method, while an advertisement is provided when the user visits the web page, an advertisement is not provided on a first page of a web browser which has relatively high influence.

Due to these facts, it is difficult to accomplish high advertisement effect when using the conventional target advertisement method in a mobile communication terminal.

### SUMMARY OF THE INVENTION

Accordingly, the present invention has been made in an effort to solve the problems occurring in the related art, and an object of the present invention is to, in a web browser installed in a mobile communication terminal, analyze keywords inputted into a search box by a user and site visit information such as addresses (URLs) of web sites visited by the user and duration times in respective sites, extract user preference information, expect keywords having high probability for the user to input based on the preference information, and realize a target advertisement on a first page of the web browser.

Another object of the present invention is to, when implementing target advertisement, correlate personal information, position information and a user's web browser using time information stored in a mobile communication terminal with keywords so that the preciseness of the target advertisement is improved.

Still another object of the present invention is to extract keywords necessary for target advertisement while maximally suppressing the use of a processor (CPU), a memory and a network of a mobile communication terminal in consideration of limited resources of the mobile communication terminal.

In order to achieve the above objects, according to one aspect of the present invention, there is provided a target advertisement system in a mobile communication terminal, comprising a web browser configured to transmit, to an advertisement server via the Internet, keywords having high probability indexes among previously stored keywords when the web browser is initially driven, and display advertisements transmitted from the advertisement server on a first screen after the web browser is driven; and the advertisement server configured to select the advertisements appropriate for the keywords transmitted from the web browser, and transmit the selected advertisements to the web browser via the Internet.

In order to achieve the above objects, according to another aspect of the present invention, there is provided a target advertisement method in a mobile communication terminal, comprising a first step of, in a web browser, transmitting keywords having high probability indexes among previously stored keywords, to an advertisement server via the Internet in an initially driven state; a second step of, in the advertisement server, selecting advertisements appropriate for the keywords transmitted from the web browser and transmitting the selected advertisements to the web browser via the Internet; a third step of, in the web browser, displaying the advertisements transmitted from the advertisement server on a first screen of the web browser; and a fourth step of implementing an information searching function or a web surfing function in conformity with a user's desire.

### BRIEF DESCRIPTION OF THE DRAWINGS

The above objects, and other features and advantages of the present invention will become more apparent after a reading of the following detailed description taken in conjunction with the drawings, in which:

FIG. 1 is a block diagram of a target advertisement system of a mobile communication terminal in accordance with an embodiment of the present invention;

FIG. 2 is a flow chart of a target advertisement method of a mobile communication terminal in accordance with another embodiment of the present invention;

FIG. 3 is a detailed flow chart of an information search step in FIG. 2; and

FIG. 4 is a detailed flow chart of a web surfing step in FIG. 2.

### DETAILED DESCRIPTION OF PREFERRED EMBODIMENTS

Reference will now be made in greater detail to preferred embodiments of the invention, examples of which are illustrated in the accompanying drawings. Wherever possible, the same reference numerals will be used throughout the drawings and the description to refer to the same or like parts.

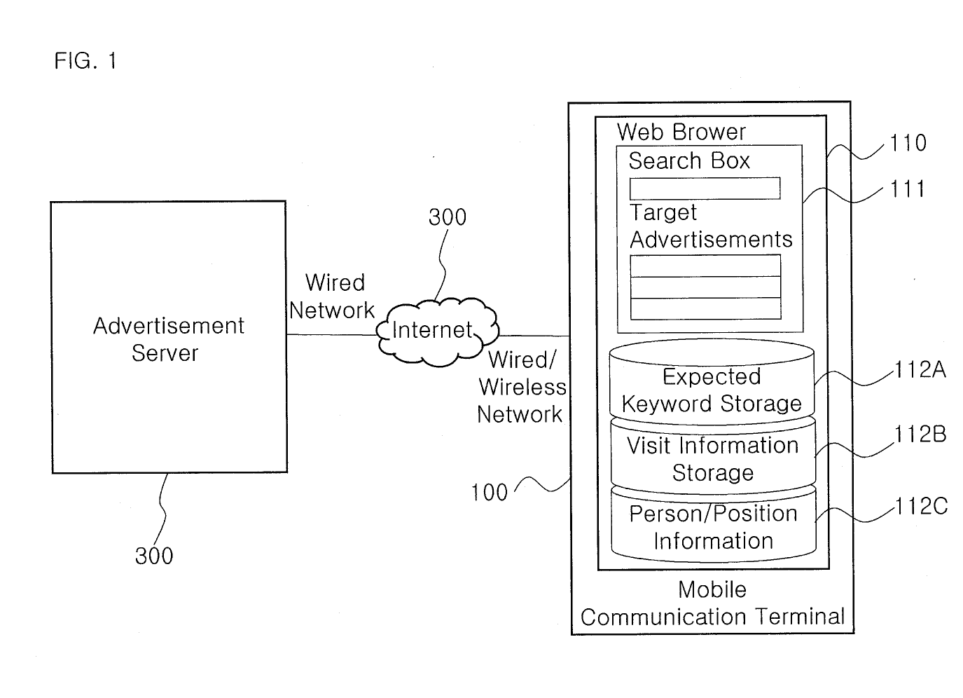

FIG. 1 is a block diagram of a target advertisement system of a mobile communication terminal in accordance with an embodiment of the present invention. Referring to FIG. 1, the target advertisement system of a mobile communication terminal includes a web browser 110 installed in a mobile communication terminal 100, an advertisement server 200, and the Internet 300 connected with the mobile communication terminal 100 via a wired or wireless network and with the advertisement server 200 via a wired network.

The web browser 110 installed in the mobile communication terminal 100 stores and administrates a user's search keywords and the user's web site visit information. If the web browser 110 is driven by the user, the web browser 110 displays a target advertisement capable of acting as a substitute for searching, on a first page by using expected keywords. At this time, a display type of the target advertisement can be a text, an image, a moving picture, and so forth.

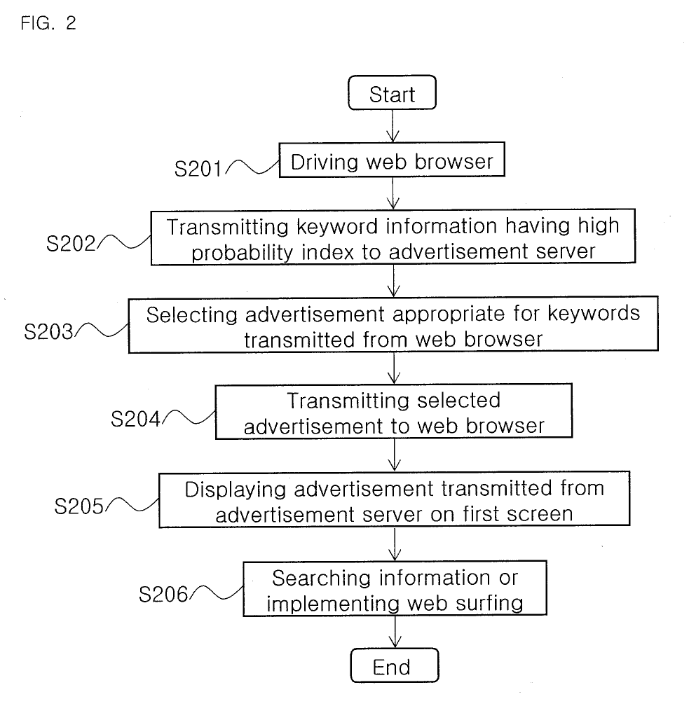

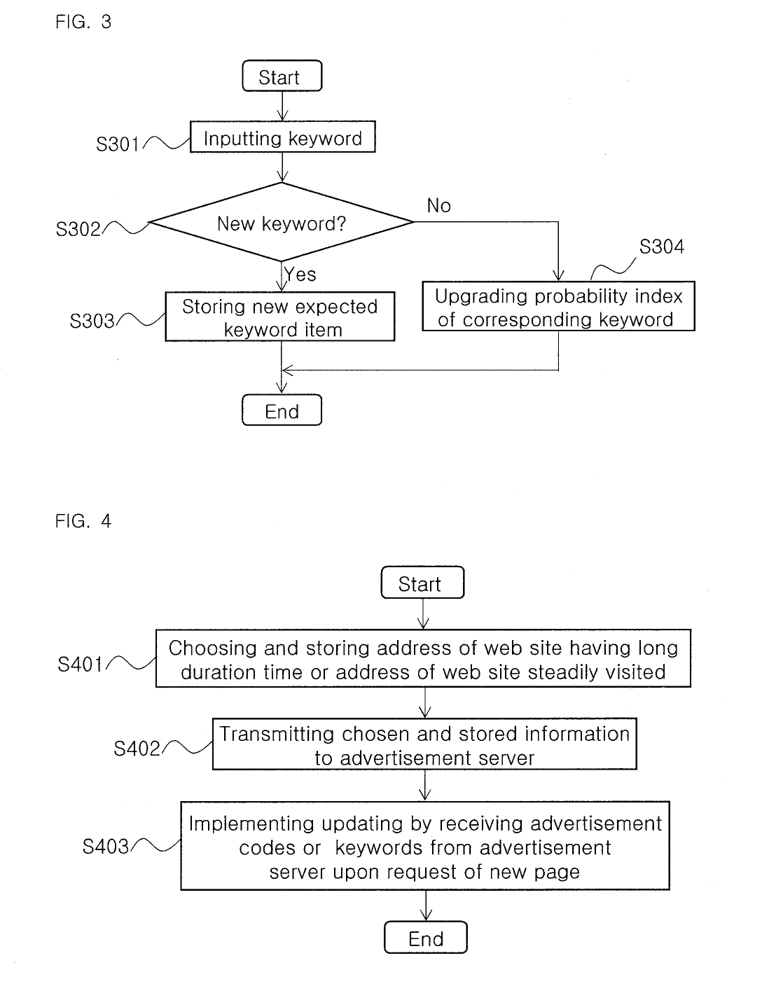

A procedure for displaying the target advertisement using the expected keywords on the first page of the web browser 100 will be described below with reference to FIGS. 2 through 4. In the following description, it is to be noted that a subject for processing information to realize the target advertisement in the mobile communication terminal 100 is the web browser 110.

If the web browser 110 is driven by the user, the web browser 110 transmits keywords high probability index among the keywords stored in an expected keyword storage 112A, to the advertisement server 200 via the Internet 300 (S201 and S202).

The advertisement server 200 selects advertisements appropriate for the keywords transmitted from the web browser 110 and transmits the selected advertisements to the web browser 110 via the path (S203 and S204). Here, as described above, the type of the advertisements can be texts, images, moving pictures, and so forth.

The web browser 110 displays the advertisements transmitted from the advertisement server 200 via the path, on a first screen 111 of the web browser 110 (S205).

Thereafter, desired information is searched through a search box in conformity with the user's desire, or the user implements web surfing by using the lists of Bookmark and/or History (S206).

When the user searches the desired information through the search box, searching keywords used at that time are used in updating the expected keyword storage 112A. The expected keyword storage 112A is stored with keywords and probability indexes of respective keywords.

If a keyword is inputted by the user, it is checked whether the keyword is a new keyword. If it is determined that the keyword is a new keyword, a new expected keyword item is additionally stored in the expected keyword storage 112A (S301 through S303).

If it is determined that the inputted keyword is a keyword that has been previously inputted or a keyword that is similar to a previously inputted keyword, the probability index of the corresponding keyword is upgraded (S304).

At this time, a probability index of a keyword can be calculated using a keyword input number, a current keyword input time and a locality of an input time as in the following Mathematical Expression 1. Keywords having high probability index among the keywords stored in the expected keyword storage 112A are transmitted to the advertisement server 200 when the user starts the web browser 100 next time and are used in determining target advertisements, as described above.

Probability Index=Previous Keyword Input Number×Current Keyword Input Time×Concentration of Keyword Input Time [Mathematical Expression 1]

When the user implements web surfing, the user visits web sites or moves to other web sites using links, bookmarks, previous visit recordings, etc.

At this time, the addresses of the web sites visited by the user and duration times are stored in a visit information storage 112B, and are used in determining target advertisements later.

The visit information storage 112B is stored with information such as URLs and preference indexes thereof, visit times and duration times. A preference index is expressed as in the following Mathematical Expression 2.

Preference Index=Visit Number×Duration Time×Visit Regularity [Mathematical Expression 2]

It is not preferred considering the calculation capability of the web browser 110 that, differently from the keyword expectation by storing search keywords as described above, keywords are expected by directly analyzing all the contents of the web sites visited by the user in the web browser 110. If this is the case, since the resources of the mobile communication terminal 100 such as a memory are excessively used, the user's site visit as an original purpose and a moving speed can be markedly retarded, and due to this fact, convenience in use of the mobile communication terminal 100 seriously deteriorate.

In consideration of this fact, the web browser 110 chooses the addresses of web sites having long duration times or addresses of web sites steadily visited with a certain time interval and stores those addresses to the visit information storage 112B (S401).

Thereafter, when driving the web browser 110 of the mobile communication terminal 100, the addresses chosen and stored as described above are transmitted to the advertisement server 200, and the analysis of the addresses is authorized to the advertisement server 200 (S402). Accordingly, it is possible to prevent a processor or a memory from being excessively used for the target advertisement.

In the meanwhile, since an amount of information such as an advertisement code or keywords assigned to a web site address is very small, upon every page request, the web browser 110 can receive the information from the advertisement server 200 and update the keyword information stored in the expected keyword storage 112A (S403).

When providing the target advertisements on the first page of the web browser 110, the visit information stored in the visit information storage 112B of the mobile communication terminal 100 such as information of time intervals during which the user uses the web browser 110 and information of times at which the web browser 110 is driven, and personal information and position information acquired by a GPS that are stored in a personal/position information storage 112C can be additionally correlated with the keywords, so that target advertisements having improved preciseness can be determined.

For example, various shopping information about delicious restaurants, clothing stores, and so on can be obtained in conformity with the sex and age of a user of the web browser 110, areas mainly visited by the user, and visit times. Then, the shopping information can be displayed in such a way as to be differentiated for each hour the user turns on the web browser 110. If the driving time of the web browser 110 corresponds to an office-going hour, shopping information or web site information helpful to work is displayed, if the driving time of the web browser 110 corresponds to a home-going hour, information of surrounding delicious restaurants or places to go is displayed.

In this case, if the user drives the web browser 110, the expected keywords, site visit information and the visit information stored in the visit information storage 112B of the mobile communication terminal 100, and the personal/position information stored in the personal/position information storage 112C are transmitted to the advertisement server 200 via the path.

Then, the advertisement server 200 synthetically analyzes the respective information transmitted form the web browser 110 and determines target advertisements.

As is apparent from the above description, according to the present invention, in a web browser installed in a mobile communication terminal, keywords inputted into a search box by a user and site visit information such as addresses (URLs) of web sites visited by the user and duration times in respective sites are analyzed, user preference information is extracted, keywords having high probability for the user to input are expected based on the preference information, and a target advertisement is realized on a first page of the web browser.

As a consequence, it is possible to display the target advertisement that has high preciseness and is capable of acting as a substitute for searching, on the first page of the web browser, and due to this fact, the user's choice for selecting an advertisement can be widened.

Also, when implementing target advertisement, personal information, position information and the user's web browser using time information stored in the mobile communication terminal are correlated with the keywords, whereby the preciseness of the target advertisement can be improved.

Further, when implementing the target advertisement, the resources of an advertisement server are maximally utilized, so that the use of the resources of the mobile communication terminal can be minimized.

Although preferred embodiments of the present invention have been described for illustrative purposes, those skilled in the art will appreciate that various modifications, additions and substitutions are possible, without departing from the scope and the spirit of the invention as disclosed in the accompanying claims.

What is claimed is:

1. A target advertisement system in a mobile communication terminal, comprising:
a web browser configured to transmit, to an advertisement server via the Internet, keywords having high probability indexes among previously stored keywords when the web browser is initially driven, and display advertisements transmitted from the advertisement server on a first screen after the web browser is driven; and
the advertisement server configured to select the advertisements appropriate for the keywords transmitted from the web browser, and transmit the selected advertisements to the web browser via the Internet.

2. The target advertisement system according to claim 1, wherein after the web browser displays the advertisement on the first screen, the web browser implements an information searching function or a web surfing function in conformity with a user's desire.

3. The target advertisement system according to claim 1, wherein the web browser additionally stores a new expected keyword item in an expected keyword storage when a new keyword is inputted by the user.

4. The target advertisement system according to claim 1, wherein, when the web browser realizes target advertisement in which the advertisements are displayed on the first screen, the web browser correlates visit information stored in a visit information storage such as information of time intervals during which the user uses the web browser and information of times at which the web browser is driven and personal information and position information acquired by a GPS that are stored in a personal/position information storage, with the keywords, so that the target advertisement can be precisely realized.

5. A target advertisement method in a mobile communication terminal, comprising:
a first step of, in a web browser, transmitting keywords having high probability indexes among previously stored keywords, to an advertisement server via the Internet in an initially driven state;
a second step of, in the advertisement server, selecting advertisements appropriate for the keywords transmitted from the web browser and transmitting the selected advertisements to the web browser via the Internet;
a third step of, in the web browser, displaying the advertisements transmitted from the advertisement server on a first screen of the web browser; and
a fourth step of implementing an information searching function or a web surfing function in conformity with a user's desire.

6. The target advertisement method according to claim 5, wherein types of the advertisements that are displayed on the first screen in the third step comprise any ones of texts, images, and moving pictures.

7. The target advertisement method according to claim 5, wherein, when implementing the information searching function in the fourth step, the method further comprises the step of:
additionally storing a new expected keyword item in an expected keyword storage when a keyword inputted by the user is a new keyword, or upgrading a probability index of the corresponding keyword when the inputted keyword is a keyword that has been previously inputted or a keyword that is similar to a previously inputted keyword.

8. The target advertisement method according to claim 7, wherein the probability index is calculated on the basis of a previous keyword input number, a current keyword input time, and a concentration of keyword input time.

9. The target advertisement method according to claim 7 or 8, wherein, when the user next starts the web browser, the keywords having high probability indexes are transmitted to the advertisement server so as to be used when selecting target advertisements.

10. The target advertisement method according to claim 5, wherein, when implementing the web surfing function in the fourth step, information such as addresses of web sites visited by the user, URLs and preference indexes thereof, visit times, and duration times is stored so as to be used when next selecting target advertisements.

11. The target advertisement method according to claim 10, wherein the preference index is determined by a web site visit number, a duration time, and a visit regularity.

12. The target advertisement method according to claim 5, wherein the fourth step comprises the step of:
choosing and storing addresses of web sites having long duration times or addresses of web sites steadily visited with a certain time interval, and authorizing analysis of the addresses to the advertisement server.

13. The target advertisement method according to claim 5, wherein the fourth step further comprises the step of:
receiving from the advertisement server an advertisement code or keywords assigned to a web site address every time the web browser requests each page to the advertisement server, and updating the keywords stored in the expected keyword storage.

14. The target advertisement method according to claim 5, further comprising the step of:
transmitting, by the web browser, the expected keywords, site visit information and previously stored web site visit information, personal information and position information to the advertisement server, and synthetically analyzing, by the advertisement server, the respective information transmitted form the web browser and determining advertisements to transmit to the web browser.
